(19) United States
(12) Patent Application Publication
(10) Pub. No.: US 2010/0191649 A1
(43) Pub. Date: Jul. 29, 2010

(54) SYSTEM AND METHOD FOR PERFORMING ELECTRONIC TRANSACTIONS

(75) Inventors: Norbert Albrecht, Berlin (DE); Friedhelm Kunemund, Berlin (DE); Gerd Zinke, Berlin (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/089,534

(22) PCT Filed: Oct. 6, 2006
(86) PCT No.: PCT/IB2006/004210

§ 371 Date: Apr. 5, 2010

(30) Foreign Application Priority Data
Oct. 6, 2005 (EP) 05021850.2

(51) Int. Cl. G06Q 40/00; G06K 5/00

(52) U.S. Cl. 705/44; 235/382

(57) ABSTRACT

In an embodiment, an arrangement for executing electronic card payment transactions includes first card reading means (10) for reading data from a payment card (12) and a first process machine addressing the first card reading means, which process machine is set up, in response to the reading of card data by the first card reading means, to cause the sending of an electronic authorization request to a remote transaction authorization system (14, 16). The arrangement further includes storage means (18) for storing an electronic authorization reply returned by the transaction authorization system in response to the authorization request. Second reading means (20-24) separate from the first reading means serve for the second-time reading of data from the payment card (12), a second process machine addressing the second card reading means being set up, in response to the second-time reading of card data by the second card reading means, to query the authorization reply stored in the storage means.

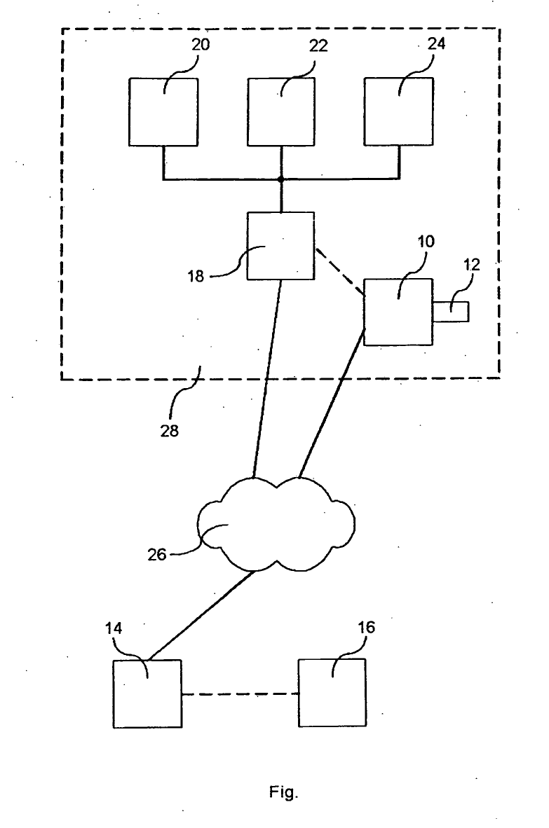

The invention deals with the execution of electronic transactions. Specifically considered within the scope of the invention are electronic transactions in which characteristic data is read by a transaction authorization means of a participant in a transaction, and the transaction is processed using the characteristic data that was read.

One example of a transaction authorization means is payment cards, which can be used by the card holder to pay for goods or services and/or to obtain cash. Various data, which can be read by means of a card reader, is stored in a machine readable memory of the payment card. The memory can be a magnetic strip or an embedded chip, for example. The stored data includes, for example, account data (account number, bank identification code), an expiry date for the card, a card number, a chip number, etc. Cards frequently used are debit cards. These enable direct debit payments, which are payments in which the amount of payment is directly debited from the account. A direct debit payment can be authorized by the card holder by a personal signature on a debit slip for example, or by entry of a personal identification number (PIN) at a card terminal. Another variant of a payment card is the credit card, for example.

It goes without saying that within the scope of the invention the physical manifestation of the transaction authorization means is irrelevant, so long as it contains appropriate characteristic data which is suitable for checking the transaction authorization and/or for identifying the holder of the transaction authorization means. The transaction authorization means can even be designed for active output of the characteristic data. For example, it is feasible for transaction authorization means to be implemented with a so-called RF chip (radio frequency chip) or equipped with such a chip, the necessary characteristic data being emitted by radio by the chip and then being received and processed by a reading means.

In some electronic transaction processes, in particular payment transactions, execution of an online authorization is known. Thus for example a signature-based direct debit card payment method is known in which a card terminal first sends an electronic message to a central authorization body for card checking, with the account data read from a debit card that was used as a means of payment, before it allows a payment transaction with the card. Such an authorization also takes place with PIN-based direct debit card payment methods, in this case actually through a central authorization body that is run by the institute issuing the card and has access to the card account, so that the credit standing and the available balance of the card holder can be checked by the central authorization body. In each case, the called central authorization body returns an electronic message containing information on whether the card is accepted, and if applicable whether the desired transaction is permitted. The signal traffic for online authorization is handled for example via a public telephone network, the Internet or another data communication network.

In view of the expectation of paying customers and till staff too, that the online authorization will not cause any significant delay to payment transactions, it is immediately clear that the online authorization is an extremely time-critical operation. The signal traffic occurring within an online authorization and the authorization check itself must be managed in a correspondingly time-critical manner. The necessary cost for protocols and resources for the signal transmission and data processing is correspondingly high, especially remembering that in a large-scale networked payment transaction system a great many online authorizations can be requested from different payment terminals at practically the same time.

It is therefore the object of the invention to set forth a way in which time-critical signal traffic and time-critical checking processes and the related high cost for data communication and data processing can be reduced in the processing of transactions that require an authorization.

From the standpoint of the device, the invention suggests for achieving this object an arrangement for executing electronic transactions, comprising
first reading means for reading one or more items of identification information from an identification information carrier object,
a first process machine, addressing the first reading means and set up to cause the sending of an electronic authorization request to a remote transaction authorization system in response to the reading of at least one item of identification information by the reading means,
storage means for storing an electronic authorization reply returned by the transaction authorization system in response to the authorization request,
separate from the first reading means, second reading means for reading characteristic data from a transaction authorization means, and
a second process machine, addressing the second reading means and set up to cause a query of an authorization reply stored in the storage means, in response to the reading of characteristic data by the second reading means.

From the standpoint of the method, the above object is achieved according to the invention with a method for executing electronic card payment transactions, comprising the following steps:
execution of a first read operation, in which one or more items of identification information are read from an identification information carrier object,
sending of an electronic authorization request to a remote transaction authorization system in response to the first read operation,
storage of an electronic authorization reply returned by the authorization system in response to the authorization request,
execution of a second read operation, in which characteristic data is read from a transaction authorization means, and
in response to the second read operation, causing of a query of an authorization reply stored in the storage means.

In the invention, a two-time time-separated read operation takes place, the first read operation being the trigger for the sending of an authorization request, while the second read operation is the trigger for the querying of a storage unit after an authorization reply from the called authorization system. This two-time reading principle can be utilized to subdivide the procedures involved in handling a transaction, in particular a payment transaction, into two sub-procedures separated in time from each other, namely one which covers the authorization process, and another, which covers first a memory access and—provided a positive authorization reply is stored in the storage means—all remaining terminal processes for handling the transaction. The time criticality of the authorization process can hereby be alleviated or possibly even largely eliminated, so that the demands on the software and hardware used for executing the authorization process can be significantly reduced.

The first and second process machines are machines formed from suitable software or hardware, which are intended and developed for executing one or more processes. In particular they are implemented in one or more terminal devices of a transaction system. The first reading means and the second reading means can usefully be formed by separate reading devices, installed spatially separated. However, it is also feasible to execute both reading processes with the same reading means. The identification information carrier object to be read can be the transaction authorization means itself. In this case, at least one item of identification information read in the first read operation can be identical to the characteristic data read in the second read operation, or be identically contained in this. Of course it is also conceivable that the identification information carrier object is different from the transaction authorization means. It is thus feasible that biometric information about a person participating in the transaction is read as identification information within the first read operation, so that in this case the identification information carrier object is a part of this person's body. It is also feasible that an identity document is used as identification information carrier object, and one or more items of identification information are read from such an identity document.

The storage means can be assigned to a server, which is coupled via a local network with one or more terminal devices, for example card terminals, at least a part of which in each case forms a second process machine. This local server can be called by the second process machine, to query the authorization reply. It is likewise feasible to provide the storage means directly in a terminal device.

In any case it is useful if the network component which sends the authorization request has a network address the same as the network component to which the authorization system transmits the authorization reply. Then the authorization system does not have to set up a separate communications link to the receiving component. Card terminals, for example, are usually assigned a unique terminal identification code, which they include in messages to other network components in order to identify themselves.

If the sending and receiving network components have different addresses in the network via which they are coupled with the authorization system, it is conceivable that the sending component inserts in the authorization request the address of the component intended as recipient of the authorization reply. It is also possible that a list or similar is stored in the authorization system, specifying one or more addresses of receiving components for each of various addresses of sending components. In this case a sending component need not include address information relating to the desired recipient of the authorization reply.

In a practical implementation of the invention, the first reading means can be arranged in the entrance area of a retail shop, for example. A customer who enters the shop and wants to pay with a payment card such as a debit card can insert the card in a read slot of the first reading means. The card check can thus take place while the customer chooses goods. The second reading means are arranged in the till area of the shop. For payment, the card can be inserted by the customer or the cashier in a read slot of the second reading means. Only the authorization reply then has to be retrieved, but no further online connection to the authorization system has to be set up. Instead of a transaction authorization means which, like conventional payment cards, must actively be presented by the customer, the transaction authorization means used can for example be one with an integrated radio communication chip, by means of which all read operations can be handled automatically without the customer's active participation.

The authorization request and authorization reply are messages which are transmitted via a network according to a predetermined protocol, for example a packet protocol. The message transfer in the network can be wireless and/or wire-connected.

The invention further extends to a memory medium with program code means stored on or in it, the program code means when executed by a processor-based computer arrangement causing the implementation of the method of the kind described above. The invention also includes an electric or electromagnetic signal, which represents program code means, which when executed by a processor-based computer arrangement cause the implementation of the method of the kind described above.

The invention is further explained below with the help of the single accompanying schematic drawing. This shows a block diagram of an architecture of an electronic payment system according to an example of an embodiment.

To be seen in the drawing is a reading device 10 which represents a first reading means within the meaning of the invention. The reading device 10 can be arranged for example in the entrance area of a retail shop 28, outlined with a broken line. A customer who enters the shop 28 can insert a payment card 12 in a read slot of the reading device 10 before beginning to shop. It is also feasible that the reading device 10 can read data from the card in a wireless manner, so that there is possibly no need to insert the card into a read slot of the reading device 10.

The reading device 10 reads various data from the payment card 12, in particular account data. It is programmed and developed such that it can generate an authorization request message with the data that is read, and can transmit this message via a communication network 26 to a predetermined host 14. The reading device 10 thus implements a first process machine within the meaning of the invention. The communication network 26 can in particular include a public communication network, for example the Internet or a line- or packet-switched telephone network. The host 14 forwards the authorization request message to an authorization machine 16. The authorization machine 16 checks the received data, for example against a stored list of blocked or permitted payment cards.

After the check is completed, the authorization machine 16 creates an authorization reply message, which is transmitted via the host 14 to a payment release server 18 and stored by this. The payment release server 18 forms storage means within the meaning of the invention. It is connected in a local network to (in this example) several point-of-sale terminals 20, 22, 24, which are in a till area of the shop 28 spatially separated from the location of the reading device 10. Each point-of-sale terminal 20-24 is equipped with reading means, which allow data to be read from the customers' payment cards. These reading means in the point-of-sale terminals 20-24 represent second reading means within the meaning of the invention.

For paying, the customer's card is read once again by one of the point-of-sale terminals 20-24. Each point-of-sale terminal is programmed and equipped to send a message in response to the reading of the card, to the payment release server 18, in order to retrieve the authorization reply message stored therein. The point-of-sale terminals 20-24 thus each implement a second process machine within the meaning of the invention. If a positive authorization reply message has arrived in the payment release server 18, the point-of-sale terminal concerned completes the payment transaction. If no authorization reply message or a negative authorization reply message has arrived in the payment release server 18, the point-of-sale terminal aborts the payment transaction, with the possibility of outputting a corresponding message on an optical display field not shown in detail or a monitor.

The retrieval of the authorization reply message from the payment release server 18 can take place reliably in considerably less time than an online authorization via the Internet or a public telephone network.

The reading device 10 can be linked into the local network, by which the payment release server 18 and the point-of-sale terminals 20-24 are connected. This is indicated in the drawing with a broken line. In this case the payment release server 18 can send the authorization request message, for which it receives the card data beforehand from the reading device 10 which read the data. This has the advantage that the same communication connection can be used both for transmitting the authorization request message and also for transmitting the authorization reply message between the host 14 and payment release server 18. Regardless of the route by which the authorization request message is transmitted to the host 14 (via the payment release server 18 or directly from the reading device 10), a communication connection between the reading device 10 and the payment release server 18 enables the latter to receive information about each card whose data is read by the reading device 10. This enables a unique association of a received authorization reply message to a card.

It is conceivable that the payment release server 18, after an authorization reply message has been queried once from a point-of-sale terminal, deletes this authorization reply message or flags it as invalid or expired. In this case a new authorization must be obtained each time when a customer wants to make purchases in the shop. However, it is equally conceivable that an authorization once granted is valid for more than one query. In this case the customer can make several successive purchases in the shop, without each time having to have his card read by the reading device 10 and authorized. For example, the authorization reply message can have unlimited validity, or only for a predetermined period of time and/or for a predetermined number of queries.

The data communication between the reading device 10, the host 14 and the payment release server 18 can usefully be encrypted, in order to increase the security of the data transfer. The authorization reply message can also be stored in encrypted form.

The query of an authorization reply message by a point-of-sale terminal can take place for example in such a way that in response to the reading of the data stored in a payment card, a transaction request message is sent from the point-of-sale terminal to the payment release server 18, this message containing the account data of the card or another number identifying the card. The payment release server 18, which for example can be formed by a personal computer (PC), searches in a database or other form of data storage arrangement in response to the receipt of the transaction request message, to find out whether information about an authorization reply from the authorization system is held in this data storage for the card concerned. It then sends a corresponding message to the relevant point-of-sale terminal, containing information about the reply from the authorization system or an indication that no reply message has been received from the authorization system.

The authorization reply message from the authorization system can contain information about an authorized lump sum or maximum transaction amount and/or a time/date stamp, specifying until when the authorization is valid. Alternatively or additionally the authorization reply message from the authorization system can contain information about a status of the card holder. The status can refer to a credit standing of the card holder, or details of the business done by the card holder so far with the dealer concerned. The lump sum or maximum transaction amount can be a credit limit for the customer, for example.

With the transaction request message, a point-of-sale terminal also retrieves the above exemplary information from the payment release server 18, so that the terminal can e.g. check whether the amount to be paid by a customer is below the authorized transaction amount. For example, if the point-of-sale terminal finds out that the payment amount is above the authorized transaction amount or the customer's status is not sufficiently good, this terminal can be set up to establish an online communication connection to the host 14 or to a host of another suitable authorization point, in order to handle the payment transaction in the normal way.

1. Arrangement for executing electronic transactions, comprising
first reading means for reading one or more items of identification information from an identification information carrier object,
a first process machine, addressing the first reading means and set up to cause the sending of an electronic authorization request to a remote transaction authorization system in response to the reading of at least one item of identification information by the reading means,
storage means for storing an electronic authorization reply returned by the transaction authorization system in response to the authorization request,
separate from the first reading means, second reading means for reading characteristic data from a transaction authorization means, and
a second process machine, addressing the second reading means and set up to cause a query of an authorization reply stored in the storage means, in response to the reading of characteristic data by the second reading means.

2. Arrangement according to claim 1, characterized in that the first reading means and the second reading means are formed by separate reading devices, installed spatially separated.

3. Arrangement according to claim 1, characterized in that the storage means are assigned to a server, which is coupled via a local network with one or more terminal devices, at least a part of which in each case forms a second process machine.

4. Method for executing electronic card payment transactions, comprising the following steps:
execution of a first read operation, in which one or more items of identification information are read from an identification information carrier object,
sending of an electronic authorization request to a remote transaction authorization system in response to the first read operation,
storage of an electronic authorization reply returned by the authorization system in response to the authorization request,
execution of a second read operation, in which characteristic data is read from a transaction authorization means, and
in response to the second read operation, causing of a query of an authorization reply stored in the storage means.

5. Memory medium with program code means stored on or in it, the program code means when executed by a processor-based computer arrangement causing the implementation of the method according to claim 4.

6. Electric or electromagnetic signal, which represents program code means, which when executed by a processor-based computer arrangement cause the implementation of the method according to claim 4.

7. Transaction authorization system for communication with an arrangement according to claim 1, the transaction authorization system being set up to insert information about an authorized transaction amount into an authorization reply directed to the arrangement.
